(19) United States
(12) Patent Application Publication
(10) Pub. No.: US 2008/0061915 A1
(43) Pub. Date: Mar. 13, 2008

(54) Dry-type transformer with shielded core/coil assembly and method of manufacturing the same

(76) Inventor: Rodney Godbey, Wilson, NC (US)

Correspondence Address: ABB Inc.;Legal Dept. - 4U6, 29801 Euclid Avenue, Wickliffe, OH, 44092-1832, US

(21) Appl. No.: 11/518,682

(22) Filed: Sep. 11, 2006

(51) Int. Cl. H01F 27/02

(52) U.S. Cl. 336/96

(57) ABSTRACT

The invention is directed to a transformer and a method of manufacturing the same, wherein a core and coil assembly is disposed inside a protective case having an exterior surface that is at least partially covered with a conductive coating. An encasement comprising a dielectric resin encapsulates the protective case. An electrical conductor is electrically connected to the conductive coating and is accessible from the exterior of the encasement.

### BACKGROUND OF THE INVENTION

This invention relates to transformers and more particularly to transformers having a dry-type construction with solid insulation.

A transformer with a dry-type construction includes at least one coil mounted to a core so as to form a core/coil assembly. The core is ferromagnetic and is often comprised of a stack of metal plates or laminations composed of grain-oriented silicon steel. The core/coil assembly is encapsulated in a solid insulating material to insulate and seal the core/coil assembly from the outside environment.

One type of transformer that typically has a dry-type construction is an instrument transformer. Instrument transformers are used in measurement and protective applications, together with equipment, such as meters and relays. An instrument transformer “steps down” the current or voltage of a system to a standardized value that can be handled by associated equipment. For example, a current instrument transformer may step down current in a range of 10 to 2,500 amps to a current in a range of 1 to 5 amps, while a voltage instrument transformer may step down voltage in a range of 12,000 to 40,000 volts to a voltage in a range of 100 to 120 volts.

The solid insulating material that is used to encapsulate the core/coil assembly of a dry-type transformer is typically a thermoset polymer, which is a polymer material that cures, through the addition of energy, to a stronger form. The energy may be in the form of heat (generally above 200 degrees Celsius), through a chemical reaction, or irradiation. A thermoset resin is usually liquid or malleable prior to curing, which permits the resin to be molded. When a thermoset resin cures, molecules in the resin cross-link, which causes the resin to harden. After curing, a thermoset resin cannot be remelted or remolded, without destroying its original characteristics. Thermoset resins include epoxies, malamines, phenolics and ureas.

When a thermoset resin cures, the resin typically shrinks. Because the resin surrounds the core/coil assembly, the shrinking thermoset resin exerts high mechanical stresses and strains on the core of the transformer. These stresses and strains distort the oriented grains of the core and increase resistance to the magnetic flux flow in the laminations. This distortion and increased resistance results in higher core loss which causes the sensitivity of the transformer to decrease and diminishes the accuracy of the transformer. In addition, when the thermoset resin shrinks around edges and protrusions, cracks may form in the thermoset resin. The cracks may grow over time and compromise the insulating properties of the thermoset resin. As a result, partial discharges may occur. A partial discharge is an electrical spark that bridges the thermoset resin between portions of the core/coil assembly. A partial discharge doesn't necessarily occur at the core/coil assembly, it can occur anywhere the electric field strength exceeds the breakdown strength of the thermoset resin. Partial discharges contribute to the deterioration of the thermoset resin, which shortens the useful life of the transformer.

It would therefore be desirable, to provide a dry-type transformer wherein the core of the transformer is protected from the stresses imparted by the shrinking of the thermoset resin, and wherein partial discharges are prevented. The present invention is directed to such a transformer and a method for manufacturing the same.

### SUMMARY OF THE INVENTION

In accordance with the present invention, a transformer is provided that includes a protective case having an exterior surface at least partially covered with a conductive coating. A core and coil assembly are disposed in the protective case. An encasement encapsulates the protective case. The encasement comprises a dielectric resin. An electrical conductor is electrically connected to the conductive coating and is accessible from the exterior of the encasement.

Also in accordance with the present invention, a method of producing a transformer is provided. In accordance with the method, a protective case is provided having an exterior surface at least partially covered with a conductive coating. A core and coil assembly is placed inside the protective case. The protective case, with the core and coil assembly disposed therein, is then encapsulated in a dielectric resin. The conductive coating is connected to an electrical conductor.

### BRIEF DESCRIPTION OF THE DRAWINGS

The features, aspects, and advantages of the present invention will become better understood with regard to the following description, appended claims, and accompanying drawings where:

FIG. 1 is a schematic view of a transformer embodied in accordance with the present invention;

FIG. 2 is a perspective view of an inner case of the transformer wherein a cover and a body of the inner case are spaced apart to show a core/coil assembly which is to be mounted inside the inner case;

FIG. 3 is a perspective view of the body of the inner case;

FIG. 4 is a perspective view of an interior side of the cover of the inner case;

FIG. 5 is a sectional view of a portion of the inner case; and

FIG. 6 shows an enlarged view of a portion of the sectional view of the inner case of FIG. 5, wherein the portion is identified by the letter “D” in FIG. 5.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somwhat schematic form.

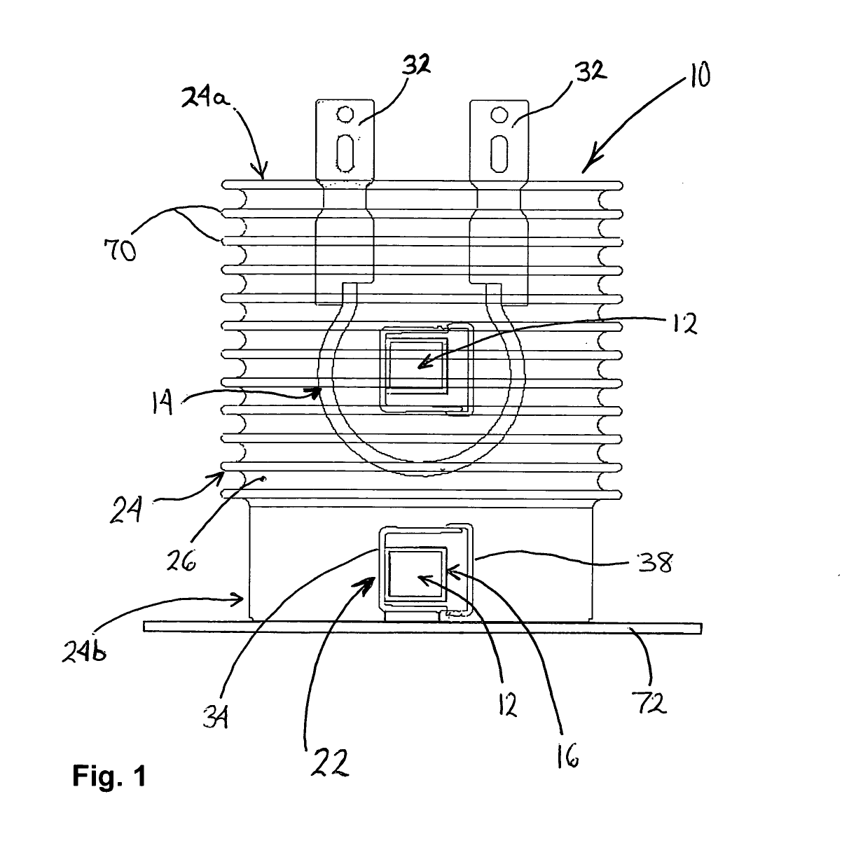

Referring now to FIG. 1, there is shown a schematic view of a transformer 10 constructed in accordance with the present invention. The transformer 10 is a current transformer adapted for exterior use. The transformer 10 generally comprises a core 12, a primary or high voltage winding 14, a secondary or low voltage winding 16, an inner housing or case 22 and an outer housing or encasement 24 formed from a resin 26. The core 12, the high voltage winding 14, the low voltage winding 16 and the inner case 22 are cast into the resin 26 so as to be encapsulated within the encasement 24. As will be described in more detail below, the inner case 22 encloses the core 12 and the low voltage winding 16 and protects them from the resin during the casting process.

The core 12 has a torroidal shape with a central opening and is composed of a ferromagnetic material, such as iron or steel. The core 12 may be comprised of a strip of steel (such as grain-oriented silicon steel), which is wound on a mandrel into a coil. The low voltage winding 16 comprises a length of wire, such as copper wire, wrapped around the core 12 to form a plurality of turns that are disposed around the circumference of the core 12. End portions of the low voltage winding 16 are secured to transformer leads 30 (or form the transformer leads 30), which are connected to a terminal board mounted to the exterior of the outer encasement 24. The combination of the core 12 and the low voltage winding 16 is hereinafter referred to as the core/coil assembly 18. The high voltage winding 14 comprises an open loop of a metallic conductor, which may be comprised of copper. The high voltage winding 14 extends through the inner case 22 and the core/coil assembly 18, as will be described more fully below. A pair of rectangular connectors 32 is secured to the ends of the high voltage winding 14, respectively.

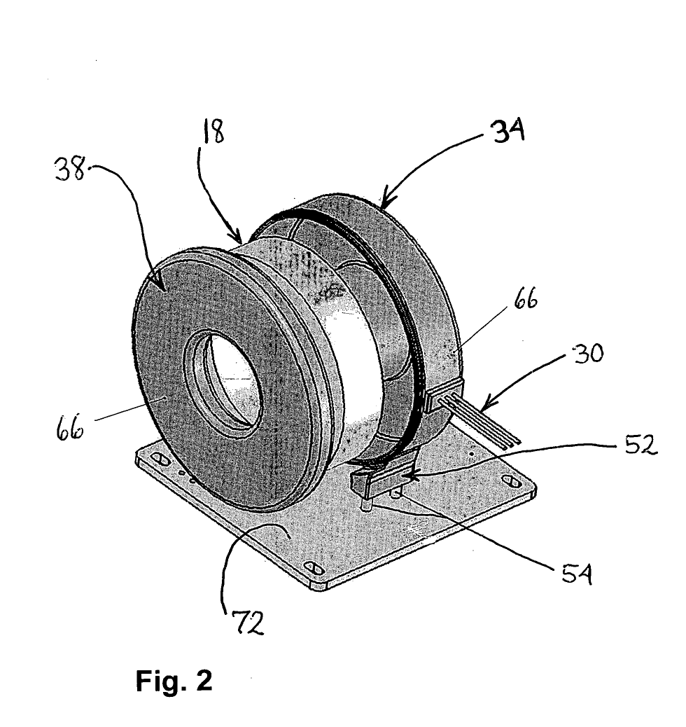

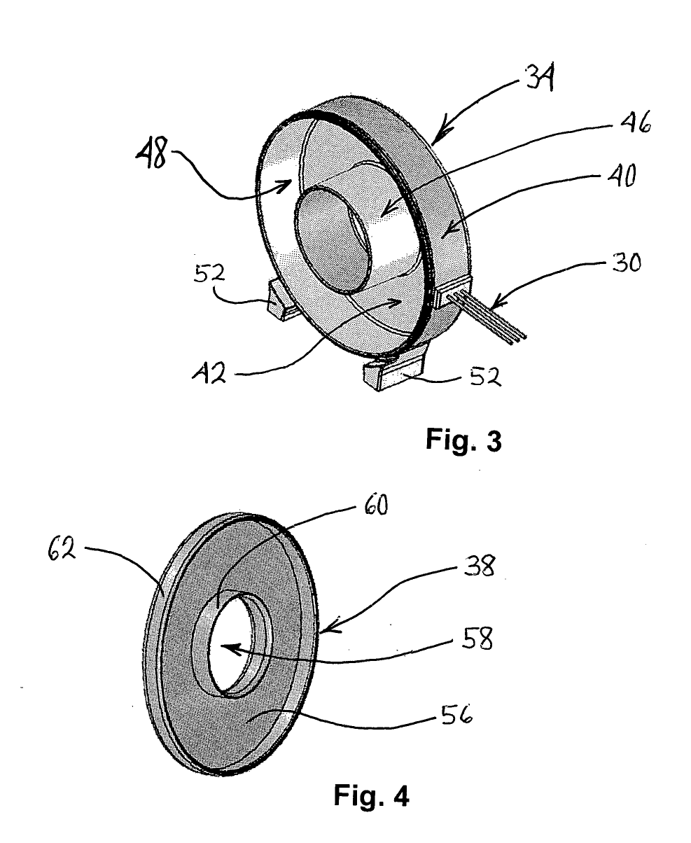

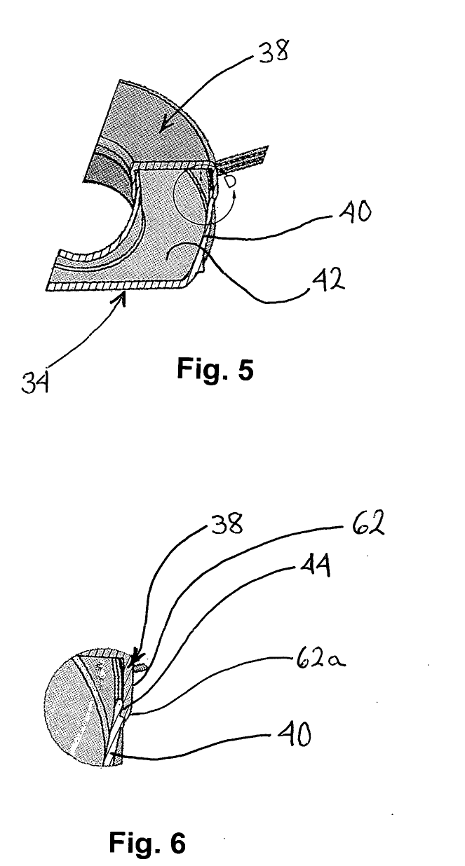

Referring now to FIGS. 2-6, the inner case 22 has a two-piece construction and comprises a body 34 and a cover 38, each of which is comprised of a high impact, dielectric plastic. Examples of a dielectric plastic that may be used include polycarbonate and an epoxy resin, such as hydrophobic cycloaliphatic epoxy resin.

The body 34 includes a cylindrical side wall 40 joined to an annular end wall 42 having an enlarged central opening. Openings are formed in the side wall 40 through which the terminal leads 30 extend. A free end of the side wall 40 has an outwardly-facing notch 44 (shown in FIG. 6) formed therein for helping secure the cover 38 to the body 34, as will be described more fully below. A cylindrical mount 46 is joined to the end wall 42, around the central opening, and extends coaxially with the side wall 40. The mount 46, however, extends away from the end wall 42 farther than the side wall 40. The side wall 40, the mount 46 and the end wall 42 cooperate to define an annular groove 48, which is adapted to receive the core/coil assembly 18. A pair of feet 52 is secured to the side wall 40, at the bottom of the body 34. A pair of gound connectors 54 is insert molded into each foot 52 (or otherwise secured to each foot 52) and extend downwardly therefrom. Each gound connector 54 has a threaded bore formed therein.

The cover 38 is annular in shape and includes a disc-shaped wall 56 with an opening 58 in the center thereof. An inner flange 60 is disposed around the opening 58 and extends away from the wall 56. An outer flange 62 (shown best in FIG. 6) is disposed around the periphery of the wall 56 and extends away therefrom. A free end 62a of the outer flange 62 is bent inwardly slightly and is shaped to fit into the notch 44 of the side wall 40 of the body 34 in an interlocking, snap-fit manner, as is shown in FIG. 6.

The exterior surfaces of the body 34 and the cover 38 are each covered with a conductive coating 66, which may be a conductive paint, or which may be formed by electroless plating or vacuum metallization. The conductive coating 66 is in contact with the gound connectors 54 so as to permit electric current to flow from the coating 50 to the gound connectors 54.

Electroless plating is an autocatalytic, chemical plating process that produces a pure, continuous and uniform coating of a metal, such as copper. In an embodiment where electroless plating is utilized, the conductive coatings may each be a duplex coating comprising a layer of electrolessly-deposited pure copper with an overcoat of electrolessly-deposited nickel-phosphorous alloy.

Vacuum metallization is principally the vacuum deposition of aluminum. In an embodiment where vacuum metallization is used, the body 34 and cover 38 are placed in a chamber containing a piece of pure aluminum disposed on a heated evaporator unit. A vacuum is pulled in the chamber and the body 34 and the cover 38 are rotated. Aluminum vapor from the evaporator unit condenses on the body 34 and the cover 38, as they rotate, thereby producing the conductive coatings, which are composed of aluminum.

Conductive paint comprises a binder, a carrier and conductive particles or pigment. The binder is a polymeric material that adheres to the plastic of the body 34 and the cover 38. The binder may be an acrylic, an acrylic emulsion, polyvinyl acetate (PVA), polyvinyl chloride (PVC), an epoxy, or a mixture of the foregoing, such as PVA/acrylic, PVC/acrylic, a PVA/acrylic emulsion, or a PVC/acrylic emulsion. More particularly, the binder may be selected from the group consisting of methyl acrylate, ethyl acrylate, methyl methacrylate, ethyl methacrylate, allyl methacrylate, n-butyl methacrylate, isobutyl metacrylate, epoxys, polyvinyl chloride, polyvinyl acetate, polyvinylidine chloride, and mixtures thereof. The carrier may be an organic solvent selected from the group consisting of methyl alcohol, ethyl alcohol, isopropyl alcohol, ethyl acetate, methylpyrrolidone, acetone, methyl cellusolve, ethyl cellusolve, butyl cellusolve, methyl ethyl ketone (MEK), methyl n-butyl ketone (MBK) and mixtures of the foregoing. Water may also be used as the carrier, or as a co-carrier. The conductive particles are finely divided metallic particles and may be selected from the group consisting of silver, copper, nickel, silver-plated copper, conductive carbon, graphite and mixtures thereof. Other binder-compatible components may also be included in the conductive paint, such as surfactants, emollients, wetting agents and thickeners. The total solids content of the conductive paint is from about 20 weight percent to about 60 weight percent, more particularly from about 30 weight percent to about 40 weight percent. The dried conductive paint, at a thickness of 1 mil, has a resistance of less than 5,000 ohms/sq, more particularly less than 1,000 ohms/sq, still more particularly, less than 500 ohms/sq. The conductive paint may be applied to the body 34 and the cover 38 by brush or by a spray gun.

In one embodiment of the present invention, the conductive coating 66 has a thickness from about 1 mil to about 3 mil, more particularly from about 1.5 mil to 2.5 mil and is a water-based conductive paint comprising a thermoplastic binder and graphite particles. A commercially available conductive paint that may be used for the conductive coating is DX-1584-B-III, which is sold by Kemco International Associates of St. Petersburg, Fla.

The core/coil assembly 18 is disposed in the groove 48 of the body 34 so that the core/coil assembly 18 abuts the end wall 42 and the mount 46 extends through the central opening of the core/coil assembly 18. While the core/coil assembly 18 is so positioned, the cover 38 is placed over the body 34 such that the mount 46 is disposed inside the cover 38, against the inner flange 60, and the free end 62a of the outer flange 62 is snapped into the outer notch 44 of the side wall 40 of the body 34. In this manner, the cover 38 is secured to the body 34 in a snap-fit manner so as to enclose the core/coil assembly 18 in the inner case 22 and thereby seal the core/coil assembly 18 from the resin 26 when the inner case 22 with the core/coil assembly 18 is cast into the resin 26 to form the outer encasement 24, as will be described below.

The resin 26 may be butyl rubber or an epoxy cast resin. In one embodiment of the present invention, the resin 26 is a cycloaliphatic epoxy resin, more particularly a hydrophobic cycloaliphatic epoxy resin. In this embodiment, the outer casement 24 is formed from the resin 26 in an automatic pressure gelation (APG) process. In accordance with APG process, the resin 26 (in liquid form) is degassed and preheated to about 40° C. to about 60° C., while under vacuum. The inner case 22 with the core/coil assembly 18 disposed therein is placed in a cavity of a mold heated to a curing temperature of the resin 26. The transformer leads 30, the connectors 32 and the ground connectors 54 extend out of the cavity so as to protrude from the encasement 24 after the casting process. The degassed and preheated resin 26 is then introduced under slight pressure into the cavity containing the inner case 22. Inside the cavity, the resin 26 quickly starts to gel. The resin 26 in the cavity, however, remains in contact with pressurized resin 26 being introduced from outside the cavity. In this manner, the shrinkage of the gelled resin 26 in the cavity is compensated for by subsequent further addition of degassed and preheated resin 26 entering the cavity under pressure. As the resin 26 gels and fully cures, the resin 26 shrinks and applies forces against the inner case 22. The inner case 22 protects the core/coil assembly 18 from these forces, thereby preventing the oriented grains of the core 12 from becoming distorted.

It should be appreciated that in lieu of being formed pursuant to an APG process, the encasement 24 may be formed using a compression molding process or a vacuum casting process.

After the resin 26 cures, the solid encasement 24 with the inner case 22 molded therein is removed from the mold cavity. The solid encasement 24 includes a top portion 24a with a plurality of annular fins or skirts 70 formed therein and a bottom portion 24b with a flat end wall. The connectors 32 for the high voltage winding 14 protrude upwardly from the top portion 24a, while the transformer leads 30 protrude laterally from the bottom portion 24b. A housing (not shown) containing a terminal board is secured to the bottom portion 24a of the encasement 24. The transformer leads 30 are disposed in the housing and are connected to the terminal board. The ground connectors 54 extend through the end wall of the bottom portion 24a such that end surfaces of the ground connectors 54 are substantially flush with the end wall. A base plate 72 composed of a conductive metal, such as aluminum, is secured to the end wall of the bottom portion 24a by screws or other fastening means. Openings in the base plate 72 are aligned with the bores in the ground connectors 54. Screws composed of a conductive metal are inserted through the openings in the base plate 72 and are threadably received in the bores in the ground connectors 54. Heads of the screws abut an exterior surface of the base plate 72. Thus, the screws form electrical connections between the base plate 72 and the ground connectors 54. When the transformer 10 is installed for use, the base plate 72 is electrically connected to an earth ground. Since the base plate 72 is electrically connected to the ground connectors 54, which are electrically connected to the conductive coating 66, the conductive coating 66 becomes grounded as well. In this manner, the conductive coating 66 forms a Faraday shield around the core/coil assembly 18. This Faraday shield will help reduce, if not eliminate, partial discharges that can damage the encasement 24.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A transformer comprising:
a protective case having an exterior surface at least partially covered with a conductive coating;
a core and coil assembly disposed in the protective case;
an encasement encapsulating the protective case, the encasement comprising a dielectric resin; and
an electrical conductor electrically connected to the conductive coating and accessible from the exterior of the encasement.

2. The transformer of claim 1, wherein the protective case comprises a cover releasably secured to a body.

3. The transformer of claim 1, wherein the dielectric resin comprises an epoxy resin.

4. The transformer of claim 3, wherein the dielectric resin comprises a hydrophobic cycloaliphatic epoxy resin.

5. The transformer of claim 1, wherein the protective case is comprised of plastic.

6. The transformer of claim 5, wherein the protective case is comprised of polycarbonate.

7. The transformer of claim 5, wherein the protective case is comprised of hydrophobic cycloaliphatic epoxy resin.

8. The transformer of claim 1, wherein the conductive coating is a conductive paint comprising a binder, a carrier and conductive particles.

9. The transformer of claim 8, wherein the binder comprises a thermoplastic resin and wherein the carrier comprises water.

10. The transformer of claim 9, wherein the conductive particles comprise graphite.

11. The transformer of claim 1, wherein the core and coil assembly comprises a secondary winding wound around a torroidal core.

12. The transformer of claim 11, further comprising a primary winding extending through the torroidal core.

13. The transformer of claim 12, wherein the primary winding comprises an open loop of a metallic conductor.

14. The transformer of claim 1, wherein the electrical conductor comprises a metallic plate secured to the encasement.

15. The transformer of claim 14, wherein the metallic plate is connected to the conductive coating by ground conductors secured to the protective case.

16. The transformer of claim 15, wherein the metallic plate is connected to earth ground, thereby grounding the conductive coating and forming a faraday shield around the core and coil assembly.

17. A method of producing a transformer comprising:
providing a protective case having an exterior surface at least partially covered with a conductive coating;
providing a core and coil assembly;
placing the core and coil assembly inside the protective case;
encapsulating the protective case, with the core and coil assembly disposed therein, in a dielectric resin; and
connecting the conductive coating to an electrical conductor.

18. The method of claim 17, wherein the protective case is encapsulated with the dielectric resin in an automatic pressure gelation process or in a vacuum casting process.

19. The method of claim 18, wherein the dielectric resin comprises a hydrophobic cycloaliphatic epoxy resin.

20. The method of claim 17, wherein the conductive coating is a conductive paint comprising a thermoplastic binder, water and conductive particles.
